(19) United States
(12) Patent Application Publication
(10) Pub. No.: US 2005/0259292 A1
(43) Pub. Date: Nov. 24, 2005

(54) Data processing apparatus and data processing method

(75) Inventors: Yoshiki Tokimoto, Nishiwaki-shi (JP); Yoshiyuki Tamai, Itami-shi (JP); Masami Yamada, Sennan-gun (JP); Kimie Mishima, Itami-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/956,103

(22) Filed: Oct. 4, 2004

(30) Foreign Application Priority Data
May 20, 2004 (JP) 2004-150697

(51) Int. Cl. G06K 15/00; H04N 1/387; G06F 17/00

(52) U.S. Cl. 358/1.15; 715/508; 715/513; 715/517; 358/1.18

(57) ABSTRACT

A data processing apparatus includes a receiving portion for receiving document data containing link information from a user terminal via a network, a link information extracting portion for extracting the link information from the received document data, a scanning portion for scanning an original document image, and an image data pasting portion for pasting image data scanned by the scanning portion to the received document data in accordance with the link information extracted by the link information extracting portion.

This application claims priority under 35 U.S.C. § 119 to Japanese Patent Applications No. 2004-150697 filed on May 20, 2004, the entire disclosure of which is incorporated herein by reference in its entirety.

### BACKGROUND OF THE INVENTION

1. Field of the Invention

The present invention relates to a data processing apparatus and a data processing method capable of being applied to MFPs (Multi Function Peripherals) connected to a network.

2. Description of Related Art

The following description sets forth the inventor's knowledge of related art and problems therein and should not be construed as an admission of knowledge in the prior art.

With the growth of networks, in companies or offices, it has become popular that data processing apparatuses such as MFPs are used by connecting to user terminals such as personal computers via networks.

For example, in cases where a user creates a document containing an image, according to a conventional method, a user steps over to a data processing apparatus to operate the scanner portion of the apparatus to read(scan) an original document image. The read(scanned) image data will be transmitted to a user terminal by the data processing apparatus. Then, at the user side, the user pastes the received image data to a predetermined position of an original document at the user terminal to create the document containing the image.

Japanese Unexamined Laid-open Patent Publication No. 2003-204534 discloses a data processing system dealing with moving image information capable of directly distributing moving image information from an information collection apparatus to a user terminal in accordance with an instruction of a server and the user terminal composes the prescribed number of distributed moving images on a predetermined screen to display thereon.

However, according to the aforementioned conventional technique for pasting the image data read(scanned) by the data processing apparatus at the user side, it is required for the user to perform the pasting operation of the image data at the user's terminal. Thus, the conventional technique requires a time-consuming job.

On the other hand, according to the technique disclosed in the aforementioned Japanese patent publication, moving image information to be distributed to a user terminal will be limited to the information owned by the information collection apparatus, and therefore a user's desired composite image cannot be obtained.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a data processing apparatus capable of saving the trouble of pasting image data at a user side to thereby enhance the workability and attaining any image data pasting operations desired by the user.

Among other potential advantages, some embodiments can provide a data processing method capable of saving the trouble of pasting image data at a user side to thereby enhance the workability and attaining any image data pasting operations desired by the user.

According to a first aspect of the preferred embodiment of the present invention, a data processing apparatus, comprises:
a receiving portion for receiving document data containing link information from a user terminal via a network;
a link information extracting portion for extracting the link information from the received document data;
a scanning portion for scanning an original document image; and
an image data pasting portion for pasting image data scanned by the scanning portion to the received document data in accordance with the link information extracted by the link information extracting portion.

According to a second aspect of the preferred embodiment of the present invention, a data processing method, comprises the steps of:
receiving document data containing link information from a user terminal via a network;
extracting the link information from the received document data;
scanning an original document image by scanning means to obtain image data; and
pasting the image data obtained by the scanning means to the document data in accordance with the extracted link information.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a structural view showing an image processing system including a data processing apparatus together with the processing procedures according to an embodiment of the present invention;

FIG. 2 is a block diagram showing an electrical structure of the data processing apparatus;

FIG. 3 is a view showing a display example displayed on a screen of a display portion of the data processing apparatus;

FIG. 4 is a flowchart showing a flow of processing to be performed by the data processing apparatus;

FIG. 5 is a structural view showing an image processing system including a data processing apparatus together with the processing procedures according to another embodiment of the present invention;

FIG. 6 is a flowchart showing a flow of processing to be performed by the data processing apparatus; and

FIG. 7 is a structural view showing an image processing system including a data processing apparatus together with the processing procedures according to still another embodiment of the present invention.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

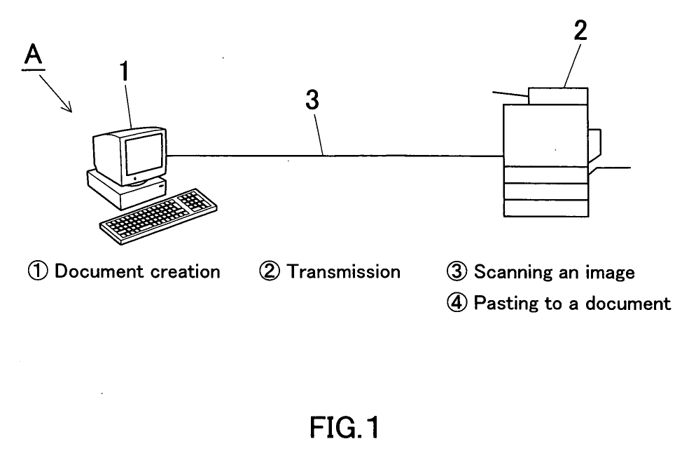

FIG. 1 shows an image processing system A including a data processing apparatus 2 together with the processing procedures according to an embodiment of the present invention.

As shown in FIG. 1, this system A includes a user terminal 1 such as a personal computer to be used by a user and a data processing apparatus 2. The user terminal 1 and the data processing apparatus 2 are connected via a network 3. The data processing apparatus 2 can be constituted by, for example, a MFP as mentioned above.

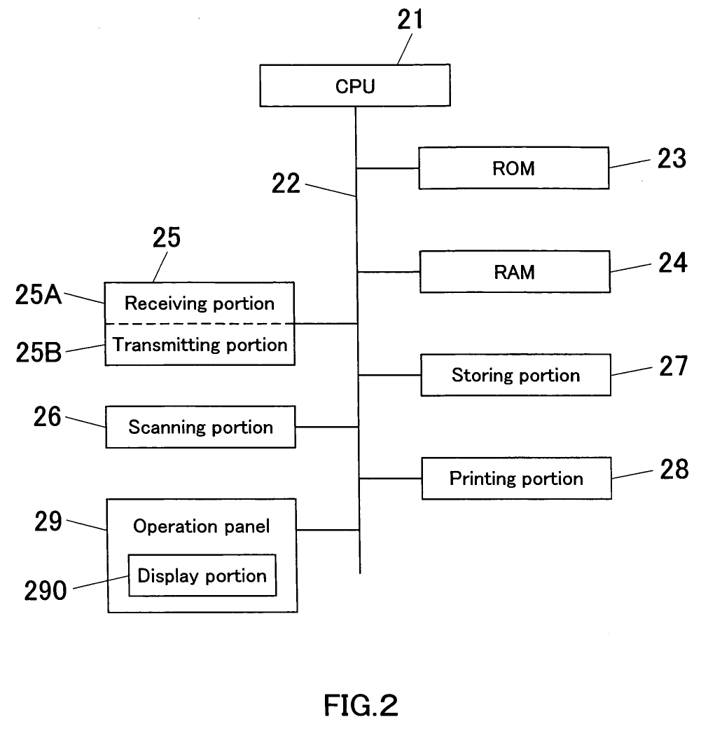

FIG. 2 shows a block diagram showing the electric structure of the data processing apparatus 2.

As shown in FIG. 2, the data processing apparatus 2 is equipped with a CPU 21. Electrically connected to the bus 22 of the CPU 21 are a ROM 23, a RAM 24, a transmitting/receiving portion 25, a scanning portion 26, a storing portion 27, a printing portion 28, an operation panel 29, etc.

The ROM 23 stores programs to be executed by the CPU 21, and the RAM 24 provides a working area to be used by the CPU 21 for executing the programs.

The transmitting/receiving portion 25 includes a receiving portion 25A for receiving document data, etc., transmitted from the user terminal 1 and a transmitting portion 25B for transmitting a document created at the data processing apparatus 2 to the user terminal 1, etc.

The scanning portion 26 is used to read(scan) an original document image disposed on an original glass plate (not shown). In the following explanation, “reading(read)” may also be referred to as “scanning(scan).”

The storing portion 27 temporarily stores received document data from the user terminal 1 and/or image data read by the scanning portion 26.

The printing portion 28 prints image data scanned by the scanning portion or data in which the scanned image data is pasted to the document data onto a paper.

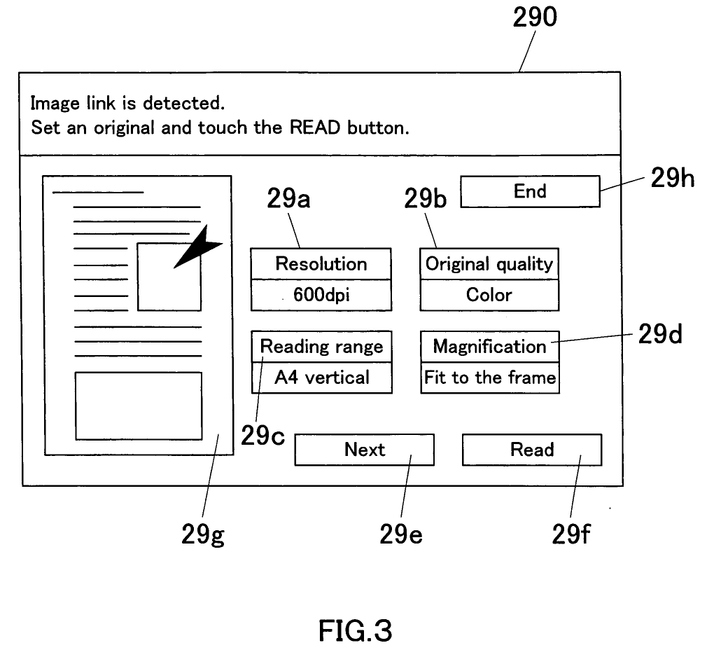

The operation panel 29 is used to instruct the data processing apparatus 2 to perform various operations, and has a display portion 290. As shown in FIG. 3, this display portion 290 is capable of displaying, for example, a resolution key 29a, an original document image quality selection key 29b, a reading range setting key 29c, a magnification setting key 29d, a “NEXT” key 29e, a “READ” key 29f, an image link display region 29g, and an “END” key 29h.

The CPU 21 has a function of generally controlling the entire data processing apparatus 2. It also has a function of extracting link information from document data transmitted from the user terminal 1 and a function of pasting image data read by the scanning portion 26 to the linked position in accordance with the link information.

In the image processing system having the aforementioned structure, as shown in FIG. 1, generally, a user creates document data containing link information at the user terminal 1 (see \mathring{1}), and then transmits the document data containing the link information to the data processing apparatus 2 via the network 3 (see \mathring{2}). The data processing apparatus 2 stores the received document data containing the link information under the control of the CPU 21. When an original document image that the user wishes to paste is scanned by the scanning portion 26 (see \mathring{3}), the data processing apparatus 2 pastes the scanned image data to the linked portion of the received document data to create a document (see \mathring{4}).

Concrete processing at the user side and the data processing apparatus side will be explained briefly.

<Actions to be Made by a User>

In creating a document containing an image, a user puts link information of the image data on a predetermined position where the image is to be inserted. As a method for putting link information, the following methods can be exemplified.
(A) Link information containing the place and file name of the image data such as a hyperlink is written in the document data in advance.
(B) A plain dummy image to be replaced with scanned image data is pasted to a document.

After creating the document data, the user transmits this document data to the data processing apparatus 2. Thereafter, the user operates the data processing apparatus 2 to read the original document image by scanning it. Then, the data processing apparatus 2 pastes the scanned image data in accordance with the given link information to complete the document. In pasting the image data, additional editing/processing can be performed.

<Processing to be made by the Data Processing Apparatus>

The data processing apparatus 2 reads an image with the scanning portion 26 and pastes the scanned image data to the document in accordance with the link information.
(a) In the case where the aforementioned method (A) is employed by the user, the data processing apparatus 2 searches the link information from the document data containing link information and places the scanned image data to the position specified by the link information.
(b) In the case where the aforementioned method (B) is employed by the user, the data processing apparatus 2 searches the image portion in the document data and performs the setting of reading range and/or resolution in view of the image size in accordance with user instructions, or automatically, to replace the plain dummy image data with the scanned image data.
(c) In the aforementioned step (a) or (b), in the case where there exist a plurality of link information, a message for urging a scanning operation will be displayed on the display portion 290 of the operation panel 29 by the number of the link information to make the user perform the scanning operation.
(d) In the aforementioned step (b), in cases where the document data includes a dummy image and an image not to be replaced (i.e., a non-dummy image), a discrimination means for discriminating between a dummy image and a non-dummy image is required.
(d-1) In the case where a plain image or a frame-only-image is pasted at the user terminal side 1, it is discriminated at the data processing apparatus side 2 that it is a dummy image, and therefore a scanned image is inserted.
(d-2) The display portion 290 of the operational panel 29 displays a thumbnail image of the dummy image pasted to the document data to inquire whether the image is to be replaced with a scanned image.

As explained above, when a user transmits document data containing link information and then scans an original document image, the scanned image data will be automatically pasted to the linked position by the data processing apparatus 2. Therefore, the user's labor for pasting image data at his/her own terminal 1 can be saved. In addition, any images desired by a user can be pasted to the document data.

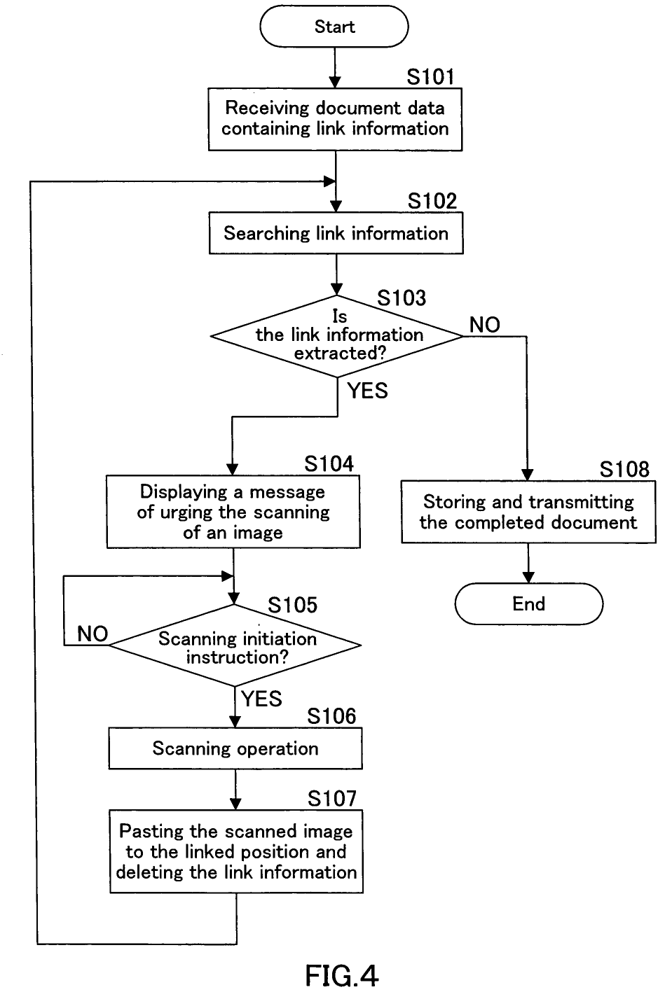

The flow of processing to be performed by the CPU 21 of the data processing apparatus 2 will be explained with reference to the flowchart shown in FIG. 4. Hereinafter, “Step” will be abbreviated as “S.”

At S101, detecting that the receiving portion 25A received document data containing link information, the CPU 21 stores the received data in the storing portion 27. Thereafter, at S102, the CPU 21 conducts a search for link information. Subsequently, at S103, the CPU 21 discriminates whether link information is extracted. If extracted (“YES” at S103), at S104, the CPU 21 causes a message for urging a user to perform an image scanning operation to be displayed on the display portion 290.

For example, as shown in FIG. 3 showing this embodiment, the CPU 21 causes the document data and the image data paste region based on the extracted link information to be displayed in the image link display region 29g, and also causes the message, ” Image link is detected. Set an original document and touch the ‘READ’ button,” to be displayed at the upper portion of the display portion 290.

Thereafter, at S105, the CPU discriminates whether a scan initiation is instructed. If the scan initiation is instructed (“YES” at S105), the routine proceeds to S106. To the contrary, if not instructed (“NO” at S105), the routine stands at S105 to wait for a scan initiation instruction.

At S106, a scanning operation is performed by the scanning portion 26. At S107, the scanned image is pasted to the linked position and then the link information is deleted. Thereafter, the routine returns to S102 and repeats the processing of S102 and S103.

On the other hand, at S103, if no link information is extracted (“NO” at S103), since it is assumed that the extracting of link information and the pasting of image data have been completed, at S108, the completed document data is stored in the storing portion 27, or transmitted to the user, to complete the job.

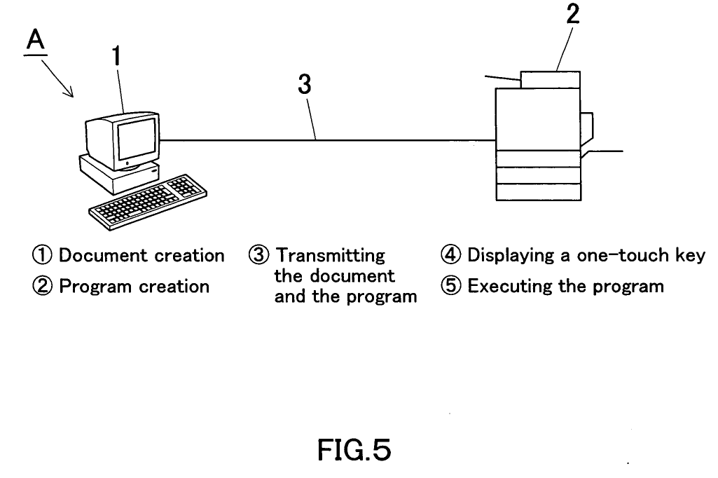

FIG. 5 is a structural view showing a data processing system A including a data processing apparatus 2 together with the processing procedures according to another embodiment of the present invention.

After the completion of transmitting document data containing link information by a user, if another user initiates a scanning operation irrelevant to the user, a document which is not intended by the user may be created. This can be prevented by locking the operational panel 29 until the user initiates the scanning of a predetermined image after the completion of transmitting the document data containing link information. However, the locking of the operational panel 29 causes operational problems. This system makes it possible to assuredly perform user's intended processing.

Although the entire structure of this system is the same as that of the first embodiment, this CPU 21 has a function of extracting link information as well as a function of extracting a paste processing program created by the user.

Furthermore, the CPU 21 causes a one-touch button (e.g., “READ” key shown in FIG. 3) for activating the scanning portion 26 by the user to be displayed on the display portion 290 of the operation panel 29 when the data processing apparatus 2 received the program, so that the user can initiate the scanning operation by touching the button.

In order to avoid complex operation on the operation panel 29 by the user, it can be configured such that a user sets various settings at the user terminal 1, transmits document data containing link information to the data processing apparatus 2 and then stores the settings to the one-touch button. Items capable of being registered to the one-touch key include, for example, a resolution, a reading range, an order of pasting images, and a destination of a completed document.

In the aforementioned structure, in the similar manner as the basic operations as shown in FIGS. 1 and 4, initially, a user creates a document containing link information at the user terminal 1 (see \mathring{1} in FIG. 5) and also creates a paste processing program (see \mathring{2} in FIG. 5) to set the communication destination or an original document mode. Then, the user transmits the document containing the link information together with the program to the data processing apparatus 2 via the network 3 (see \mathring{3} in FIG. 5).

Storing the received document containing link information in the storing portion 27 and receiving the program, the data processing apparatus 2 displays a one-touch key for activating the scanning portion 26 in the displaying portion 290 (see \mathring{4} in FIG. 5). When a user touches the one-touch key, the data processing apparatus 2 initiates a scanning operation and then executes processing in accordance with the paste processing program to create a document by pasting the scanned image data to the linked position of the received document data (see \mathring{5} in FIG. 5).

As explained above, no pasting operation will be carried out unless the one-touch key is operated. Therefore, it is possible to assuredly prevent a creation of an unintended document when unintended original document image is scanned by another user after the user's transmission of the document to the data processing apparatus 2.

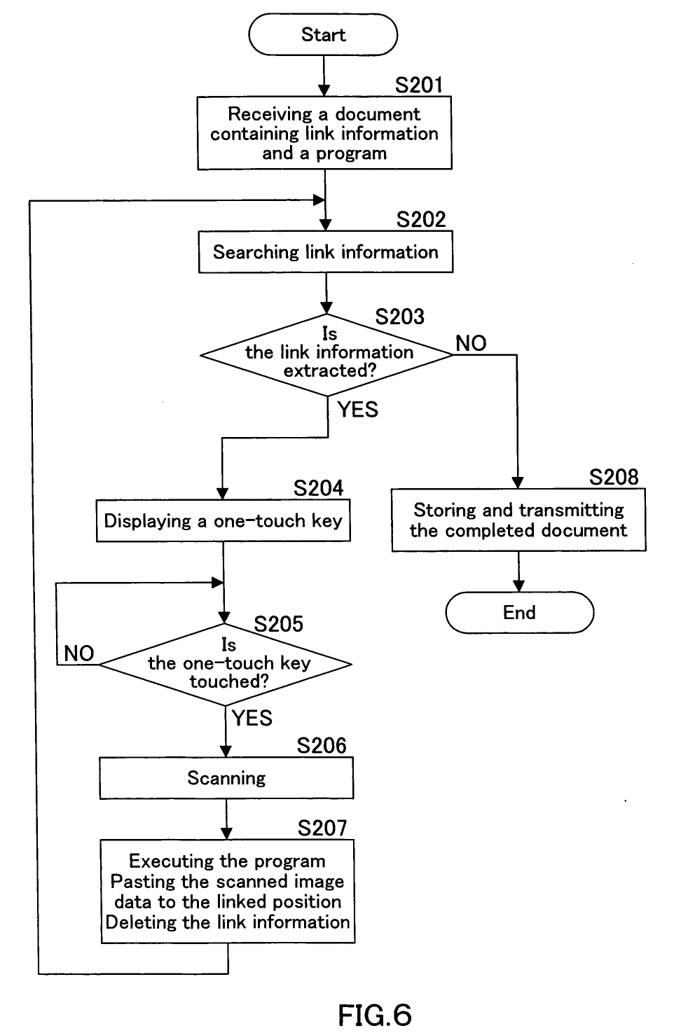

The flow of processing to be performed by the CPU 21 of the data processing apparatus 2 shown in FIG. 5 will be explained with reference to the flowchart shown in FIG. 6.

In FIG. 6, at S201, detecting a receipt of the document data containing link information and the program by the receiving portion 25A, the CPU 21 stores the document data and the program in the box 27 and then conducts a search for the link information at S202.

Subsequently, at S203, the CPU 21 discriminates whether the link information is extracted. If the link information is extracted (“YES” at S203), at S204, the CPU 21 causes a “one-touch key” to be displayed on the display portion 290.

Thereafter, at S205, the CPU 21 discriminates whether the one-touch key is touched. If the one-touch key is touched (“YES” at S205), the routine proceeds to S206. To the contrary, if the one-touch key is not touched (“NO” at S205), the CPU 21 stands at S205 to wait for the touching of the one-touch key.

At S206, the CPU 21 makes the scanning portion 26 execute the scanning operation. At S207, executing the program at S207, the CPU 21 pastes the scanned image to the linked position and then deletes the link information. Thereafter, returning to S202, the CPU 21 repeats the processing of S202 and S203.

On the other hand, at S203, if no link information is extracted (“NO” at S203), since it is assumed that the extracting of link information and the pasting of image data have been completed, at S208, the completed document data is stored in the storing portion 27, or transmitted to the user, to complete the job.

In this embodiment, it is configured that the apparatus stands ready to execute the scanning operation until the one-touch key is touched (see S205). However, it can be configured such that another job (e.g., a job for printing another document data received by the receiving portion 25A, or a job for activating the scanning portion 26, not for scanning image data to be pasted to the document data containing link information, to print the scanned image by the printing portion 28, store the image to the storing portion, or transmit the image to the user) will be accepted, or even executed.

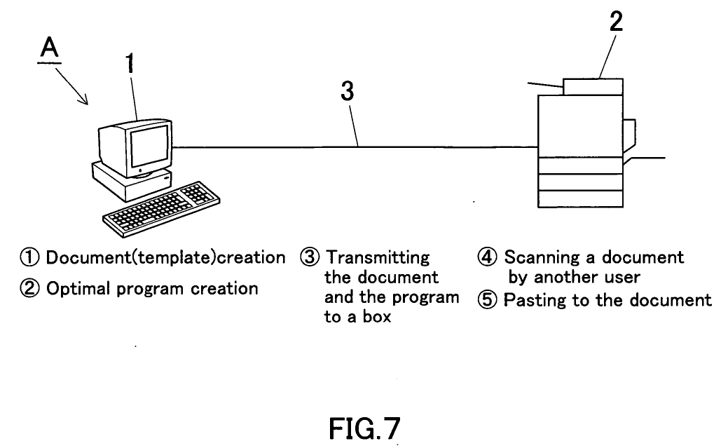

FIG. 7 is a structural view showing a data processing system including a data processing apparatus 2 according to still another embodiment of the present invention with the processing procedures.

Although the entire basic structure of this embodiment is the same as that of the above-explained embodiment, this system is configured so as to cope with the case in which a user who creates a document containing link information is different from a user who pastes image data to the document. The storing portion 27 has a box function of storing document data received by the transmitting/receiving portion 25 in a publicly accessible manner.

A user creates a document containing link information to be used by any users such as a template (hereinafter may be referred to as “template”). The data processing apparatus 2 stores the template in the storing portion (box) 27 to open to unspecified users.

If an unspecified user initiates the scanning of an original document image to be pasted to the template, the CPU 21 takes the template out from the storing portion (box) 27 and pastes the scanned image data to a predetermined position of the template in accordance with the link information.

It is recommended for a user who creates a template to set an optimal mode prepared for unspecified users in the form of program in advance. An example of the contents of such setting prepared for unspecified users includes setting capable of being applied to any image, a message of image size limitation, or an explanation of the document. Adding such setting makes it easier for unspecified users to operate the data processing apparatus 2.

In the aforementioned data processing system, a user creates a template (see \mathring{1} in FIG. 7) and also creates an optimal program for unspecified users to perform common settings or help settings (see \mathring{2} in FIG. 7). Then, the user transmits the document containing link information together with the program to the data processing apparatus 2 via the network 3 (see \mathring{3} in FIG. 7).

The data processing apparatus 2 stores the received document containing link information in the storing portion (box) 27 in a manner such that any user can access. An unspecified user other than the user who created the template selects the template stored in the box to perform the scanning of the original document image based on the settings or the help created by the user (see \mathring{4} in FIG. 7). The CPU 21 of the data processing apparatus 2 executes the processing in accordance with the program transmitted from the user to compose a document for unspecified users by pasting the image data to the linked portion of the template retrieved from the box.

The flow of the processing to be performed by the CPU 21 of the data processing apparatus 2 shown in FIG. 7 is the same as that shown in FIG. 6 except that at S206 in FIG. 6 the CPU causes an operational display for unspecified users to be displayed in the display portion 290 in accordance with the program created by the user and that at S205 the CPU discriminates whether the scanning initiation was instructed based on the operational display. Accordingly, the explanation will be omitted.

In the aforementioned explanations, in the case where the received document data contains no link information, or after the completion of pasting operation for all of the link information, the completed document data is stored in the storing portion 27 or transmitted to the user (e.g., S108 or S208). However, it can be configured such that the completed document data (the data in which the pasting operation of all of the link information is completed) or the received document data (with no link information) is printed by the printing portion 28.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A data processing apparatus, comprising:
a receiving portion for receiving document data containing link information from a user terminal via a network;
a link information extracting portion for extracting the link information from the received document data;
a scanning portion for scanning an original document image; and
an image data pasting portion for pasting image data scanned by the scanning portion to the received document data in accordance with the link information extracted by the link information extracting portion.

2. The data processing apparatus as recited in claim 1, further comprising an operation panel having a display portion capable of performing touch-input operations,
wherein the display portion is capable of displaying a document data pasting region to which the image data is pasted in accordance with the link information and a read start key for activating the scanning portion to obtain the image data to be pasted to the pasting region.

3. The data processing apparatus as recited in claim 1, further comprising an operation panel having a display portion capable of performing touch-input operations,
wherein the display portion is capable of displaying an operation key for activating the scanning portion to perform a scanning operation when a program created by the user is received together with the document data by the receiving portion, and
wherein the image data pasting portion executes image data pasting processing in accordance with the program when the operation key is touched and the scanning operation by the scanning portion is initiated.

4. The data processing apparatus as recited in claim 1, wherein the document data containing the link information is document data prepared for unspecified users, and wherein the data processing apparatus further comprises a box for storing the document data transmitted from the user terminal in a publicly accessible manner.

5. A data processing method, comprising the steps of:
receiving document data containing link information from a user terminal via a network;
extracting the link information from the received document data;
scanning an original document image by scanning means to obtain image data; and
pasting the image data obtained by the scanning means to the document data in accordance with the extracted link information.

6. The data processing method as recited in claim 5, further comprising a step of displaying a document data pasting region to which the image data is pasted in accordance with the link information and a read start key for activating the scanning means to obtain the image data to be pasted to the pasting region in a display portion of an operation panel, the display portion being capable of performing touch-input operations.

7. The data processing method as recited in claim 5, further comprising a step of displaying an operation key for activating a scanning operation of the scanning means to perform a scanning operation when a program created by the user is received together with the document data in a display portion of an operation panel, the display portion being capable of performing touch-input operations, and
wherein image data pasting processing is executed in accordance with the program when the operation key is touched and the scanning operation by the scanning means is initiated.

8. The data processing method as recited in claim 5, wherein the document data containing the link information is document data prepared for unspecified users, and wherein the data processing method further comprises a step of storing the document data transmitted from the user terminal in a box in a publicly accessible manner.
